(19) United States
(12) Patent Application Publication
(10) Pub. No.: US 2009/0315239 A1
(43) Pub. Date: Dec. 24, 2009

(54) Clamp Device and Clamping System Using Such Device

(76) Inventors: Keitaro Yonezawa, Hyogo (JP); Gaku Yoshimura, Hyogo (JP); Yosuke Haruna, Hyogo (JP)

Correspondence Address: BACON & THOMAS, PLLC, 625 SLATERS LANE, FOURTH FLOOR, ALEXANDRIA, VA, 22314-1176, US

(21) Appl. No.: 12/084,954

(22) PCT Filed: Nov. 22, 2006
(86) PCT No.: PCT/JP2006/323309

§ 371 Date: May 14, 2008

(30) Foreign Application Priority Data
Nov. 28, 2005 (JP) 2005-376357

(51) Int. Cl. B23Q 3/02

(52) U.S. Cl. 269/309

(57) ABSTRACT

In a reference block (1), a center hole (20) having a tapered inner surface (23) narrowing downward is provided. A rigid sleeve (21) having a tapered outer surface (27) making a tapering engagement with the tapered inner surface (23) is supported by the reference block (1) axially movably. During a locking drive, an output member (48) inserted into the rigid sleeve (21) is moved downward. Then, a clamping member (33) inserted into a socket hole (3) of a work pallet (2) is moved downward against an elastic member (45) and radially-outwardly for locking, and the tapered outer surface (27) of the rigid sleeve (21) makes a tapering engagement with the tapered inner surface (23).

### TECHNICAL FIELD

The present invention relates to a clamping apparatus for fixing a movable block such as a work pallet or a work to a reference block such as a table of a machine tool, and further relates to a clamping system using the clamping apparatus.

### BACKGROUND OF THE INVENTION

As such a clamping apparatus, conventionally, there is a clamping apparatus described in the following Patent Document 1 (Japanese Patent Publication No. 3550010). The prior art thereof has been proposed by an assignee of the present invention of this application, and the invention is constructed as follows.

A tapered outer peripheral surface at an upper portion of a pull rod makes an engagement with an inner peripheral surface of an annular collet from above, and the collet and the pull rod are arranged radially movably with respect to a housing. Then, when the pull rod is lowered with respect to the collet urged upward by a pressing spring, the collet diametrically expands to come into close contact with an engagement hole of a work, and the work is driven to descend via the collet.

### Patent Document 1: Japanese Patent Publication No. 3550010

### SUMMARY OF THE INVENTION

### Problem to be Solved by the Invention

The conventional apparatus has only a function of fixing a work, but does not have a function of positioning the work. Therefore, when a system in which the work is fixed after positioning thereof is constructed, it is necessary to newly install an exclusive positioning apparatus. As a result, the clamping system is complicated in its structure, and made large in size.

An object of the present invention is to provide a clamping apparatus with a positioning function and a clamping system utilizing the apparatus.

In order to accomplish the objective mentioned above, according to a first aspect of the present invention, for example, as illustrated in FIG. 1 to FIG. 4B, FIG. 6A and FIG. 6B, FIG. 8, or FIG. 9A to FIG. 9D, an apparatus which clamps a movable block 2 having a socket hole 3 to a reference block 1 is constructed as follows.

A center hole 20 is provided in the reference block 1 so as to face the socket hole 3, and the center hole 20 has a tapered inner surface 23 narrowing toward a base end. A rigid sleeve 21 is supported by the reference block 1 axially movably within a predetermined range. The rigid sleeve 21 includes a tapered outer surface 27 making a tapering engagement with the tapered inner surface 23 of the center hole 20, a projecting portion 25 projected further toward a leading end than the center hole 20 and inserted into the socket hole 3, and a cylindrical hole 21a axially extending. An advancing means 45 for pressing the rigid sleeve 21 toward the leading end is provided. An output member 48 is inserted into the cylindrical hole 21a of the rigid sleeve 21. The output member 48 is connected to a clamping member 33 provided on the projecting portion 25 so as to be inserted into the socket hole 3. A driving means D for moving the output member 48 toward the base end is provided. The output member 48 moves the clamping member 33 toward the base end against the advancing means 45 and radially-outwardly for locking, and makes the tapered outer surface 27 of the rigid sleeve 21 form a tapering engagement with the tapered inner surface 23 of the center hole 20.

Further, in the invention, the rigid sleeve is different from a sleeve elastically deformed diametrically, for example, as a collet or the like, but means a tubular member having extremely little elastic deformation.

Further, as the clamping member, a case in which an annular clamping member such as a collet is elastically deformed to radially expand and radially contract, a case in which a plurality of clamping members arranged circumferentially at intervals radially-outwardly and radially-inwardly move to radially expand and radially contract, and the like are conceivable.

As the drive means, an automatic means utilizing a fluid power actuator or the like and a manual means utilizing screw thrust force or the like are conceivable.

The present invention functions as follows, for example, as illustrated in FIG. 3A to FIG. 4B.

In a release state of FIG. 3A, the output member 48 raises the clamping member 33 toward the leading end (upward in the drawing), and the clamping member 33 is changed to be in a diametrically contracted state. Further, the rigid sleeve 21 is held at a raised position by the advancing means 45.

When the movable block 2 is positioned with respect to the reference block 1, first, the movable block 2 is lowered in the release state of FIG. 3A, and the socket hole 3 is fitted at the outside of the clamping member 33, and the movable block 2 is received by the reference block 1. Further, at the time of receiving, as illustrated in FIG. 3A, a case in which the movable block 2 is received by the reference block 1 via another member such as the rigid sleeve 21, and a case in which the movable block 2 is received directly by the reference block 1 are conceivable.

As illustrated in a locking start state of FIG. 3B, when the output member 48 is lowered, first, the clamping member 33 diametrically expands (or radially-outwardly moves) via the rigid sleeve 21 held substantially at the raised position by the advancing means 45 to come into contact with the socket hole 3.

Next, as illustrated in a half-locked state of FIG. 4A, the clamping member 33 further diametrically expands with respect to the rigid sleeve 21 pressed upward by the advancing means 45, and the clamping member 33 comes into close contact with an inner peripheral surface of the socket hole 3.

Then, as illustrated in FIG. 4B, the rigid sleeve 21 is lowered against the advancing means 45, and the tapered outer surface 27 of the rigid sleeve 21 makes a tapering engagement with the tapered inner surface 23 of the center hole 20. Thereby, the rigid sleeve 21 is radially (horizontally) and axially (vertically) constrained by the reference block 1 via the tapering engagement. And, the movable block 2 is horizontally positioned with respect to the reference block 1 via the rigid sleeve 21 in the constrained state and the clamping member 33 in the close contact state with the socket hole 3. Substantially at the same time, the output member 48 is driven to further descend with respect to the rigid sleeve 21, and the output member 48 presses the movable block 2 downward via the clamping member 33. Thereby, the supported surface 2a of the movable block 2 is strongly pressed onto the support surface 1a of the reference block 1.

Accordingly, the present invention brings about the following advantages.

Since the movable block can be clamped to the reference block after the movable block is positioned with respect to the reference block via the clamping member and the rigid sleeve, a clamping apparatus with a positioning function can be made simply and compactly.

Further, during a locking operation, the tapered outer surface of the rigid sleeve makes a tapering engagement with the tapered inner surface of the center hole, thus the rigid sleeve can be integrated with the reference block. Therefore, the rigid sleeve is enhanced in its radial (horizontal) rigidity. As a result, even when great external force such as machining reaction force during a machining process is applied to the movable block, the movable block can be held in a positioning state.

Additionally, since the rigid sleeve is an independent member different from the reference block, it is possible to inexpensively and easily exchange the rigid sleeve when the rigid sleeve is worn away. Moreover, since the rigid sleeve is an independent member, design freedom in selection of a material, selection of a wall thickness, a surface treatment, and the like is made greater, which makes it possible to manufacture the rigid sleeve with high accuracy and high rigidity. As a result, it is possible to provide a clamping apparatus which can be used in a maintenance-free manner over a long period of time.

It is preferable to add the following structure to the present invention, for example, as illustrated in FIG. 3A or FIG. 5A or FIG. 9A.

Specifically, a flange portion 28 is radially-outwardly projected from the rigid sleeve 21 outside the center hole 20, and the advancing means 45 is disposed in an annular manner between the flange portion 28 and the reference block 1.

In this case, it is possible to prevent foreign matter such as swarf from intruding into the reference block by the advancing means. Further, since the preventing means serves as the advancing means as well, the clamping apparatus has fewer number of components, and the clamping apparatus can be made simply and compactly.

In the present invention, for example, as illustrated in FIG. 3A or FIG. 9A, the annular advancing means 45 is composed of an elastic member for sealing such as rubber or synthetic resin.

In this case, it is possible to reliably prevent foreign matter such as swarf from intruding into the reference block by the elastic member.

It is preferable to add the following structure to the present invention, for example, as illustrated in FIG. 3A to FIG. 4B.

A flange portion 28 is radially-outwardly projected from the rigid sleeve 21 outside the center hole 20. In a state where the movable block 2 is placed on the flange portion 28, the advancing means 45 presses the movable block 2 to form a seating gap E between a supported surface 2a of the movable block 2 and a support surface 1a of the reference block 1. A detection hole 74 for pressurized fluid for seating confirmation is opened in the support surface 1a.

In this case, since a seating gap is formed in a state where the movable block is spaced from the reference block, and it is possible to cause the seating gap to disappear in a state where the movable block is seated on the reference block, it is possible to reliably distinguish between the spaced state and the seated state for detection.

It is preferable to add the following structure to the present invention, for example, as illustrated in FIG. 3A to FIG. 4B.

A supply port 76 for pressurized fluid for locking confirmation is provided in the reference block 1. The supply port 76 is communicatively connected to an exterior space via a locking gap F between the tapered inner surface 23 and the tapered outer surface 27. The communicative connection between the supply port 76 and the exterior space is shut off when the tapered outer surface 27 makes a tapering engagement with the tapered inner surface 23.

In this case, since a locking gap is formed in a release state, and it is possible to cause the locking gap to disappear in a lock state, it is possible to reliably distinguish between the release state and the lock state for detection.

In the present invention, for example, as illustrated in FIG. 3A, or FIG. 5A and FIG. 5B, the tapered outer surface 27 of the rigid sleeve 21 may make a tapering engagement with substantially the whole circumference of the tapered inner surface 23 of the center hole 20 provided in the reference block 1.

Further, the following structure may be added to the present invention, for example, as illustrated in FIG. 6A and FIG. 6B, or FIG. 6C or FIG. 6D.

A pair of protruding portions 80, 80 radially facing each other is provided on at least one of an inner periphery of the center hole 20 provided in the reference block 1 and an outer periphery of the rigid sleeve 21. The tapered inner surface 23 or the tapered outer surface 27 is formed to the respective protruding portions 80. Movement allowable spaces 81, 81 partitioned by the protruding portions 80, 80 are formed to radially face each other between the inner periphery of the center hole 20 and the outer periphery of the rigid sleeve 21.

In the present invention, for example, as illustrated in FIG. 3A, or FIG. 5A and FIG. 5C, the clamping member 33 is composed of a collet diametrically expandable and diametrically contractible, and the collet type clamping member 33 makes a wedge-engagement with the projecting portion 25 of the rigid sleeve 21 from the leading end side.

In the present invention, in contrast to the conventional structure mentioned above, since the clamping member makes a wedge-engagement with the rigid sleeve from the leading end side, it is possible to easily cover the wedge-engaged portion from the leading end side. Therefore, it is possible to prevent foreign matter such as swarf from intruding into the wedge-engaged portion. As a result, it is possible to use the clamping apparatus in a maintenance-free manner over a long period of time.

In the present invention, for example, as illustrated in FIG. 9A to FIG. 9D, the clamping member 33 is composed of a plurality of balls 96 arranged circumferentially at intervals on a peripheral wall of the projecting portion 25 of the rigid sleeve 21, and the output member 48 changes the respective balls 96 to radially-outward engaging positions X.

Further, it is preferable to provide at least three of the balls 96.

The present invention brings about the following advantages.

Since the clamping member composed of the balls is arranged inside the peripheral wall of the rigid sleeve, as compared with a case in which the clamping member is disposed at the outer periphery of the rigid sleeve, a portion to be inserted into the socket hole of the movable block can be made to have a small diameter. Therefore, it is possible to provide a clamping apparatus with a simple structure, which is suitable for a small diameter socket hole.

Further, the clamping member composed of the balls can be made to have a quantity of radially-outward movement greater than that of a collet type clamping member. Therefore, it is possible to enlarge a fitting gap between the socket hole of the movable block and the outer peripheral surface of the projecting portion of the rigid sleeve, which makes a fitting operation for the socket hole and the rigid sleeve easier.

In addition, since the clamping member composed of the balls has a high surface pressure, which makes it possible that the clamping member comes into strong and close contact with the socket hole while elastically deforming or plastically deforming the socket hole of the movable block, therefore great clamping force can be secured.

As a clamping system utilizing the clamping apparatus, a case where one of the clamping apparatuses according to any one of the respective inventions is provided, a case where a plurality of clamping apparatuses of a specific invention are provided, and a case where clamping apparatuses of different inventions are combined are conceivable.

### BRIEF DESCRIPTION OF THE DRAWINGS

FIG. 1 is a schematic view illustrating a principle of a clamping system utilizing the present invention, and a traverse cross-sectional view of the clamping system.

FIG. 2A is a cross section corresponding to a section taken along the line 2A-2A of FIG. 1 or FIG. 2B, illustrating a first embodiment of a first clamping apparatus of the clamping system. FIG. 2B is a plan view of the clamping apparatus.

FIG. 3A is a substantial part enlarged view of FIG. 2A, illustrating a release state of the clamping apparatus. FIG. 3B is a view similar to FIG. 3A, illustrating a locking start state of the clamping apparatus.

FIG. 4A is a view similar to FIG. 3A, illustrating a half-locked state of the clamping apparatus. FIG. 4B is a view similar to FIG. 3A, illustrating a locking completed state of the clamping apparatus.

FIG. 5A to FIG. 5C illustrate an exemplary variation of the first clamping apparatus. FIG. 5A is a view similar to FIG. 3A. FIG. 5B is a section taken along the line 5B-5B of FIG. 5A. FIG. 5C is a section taken along the line 5C-5C of FIG. 5A.

FIG. 6A and FIG. 6B illustrate a second clamping apparatus of the clamping system. FIG. 6A is a view similar to FIG. 5A, illustrating a section taken along the line 6A-6A of FIG. 6B. FIG. 6B is a section taken along the line 6B-6B of FIG. 6A. FIG. 6C is a view similar to FIG. 6B, illustrating a first exemplary variation of the second clamping apparatus. FIG. 6D is a view similar to FIG. 6B, illustrating a second exemplary variation of the second clamping apparatus.

FIG. 7A and FIG. 7B illustrate a third clamping apparatus of the clamping system. FIG. 7A is a partial view similar to FIG. 5A. FIG. 7B is a section taken along the line 7B-7B of FIG. 7A.

FIG. 8 is a view similar to FIG. 2A, illustrating a second embodiment of the first clamping apparatus.

FIG. 9A to FIG. 9D illustrate a third embodiment of the first clamping apparatus. FIG. 9A is a cross section corresponding to a section taken along the line 9A-9A of FIG. 9B, illustrating a release state of the clamping apparatus. FIG. 9B is a section in plan view of FIG. 9A. FIG. 9C is a view similar to FIG. 9A, illustrating a lock state of the clamping apparatus. FIG. 9D is a section in plan view of FIG. 9C.

### DESCRIPTION OF THE REFERENCE NUMERALS AND LETTERS

1: reference block, 1a: support surface, 2: movable block (work pallet), 2a: supported surface, 3: socket hole, 20: center hole, 21: rigid sleeve, 21a: cylindrical hole, 23: tapered inner surface, 25: projecting portion, 27: tapered outer surface, 28: flange portion, 33: clamping member, 45: advancing means (elastic member), 48: output member, 74: detection hole for pressurized fluid, 76: supply port for pressurized fluid, 80: protruding portion, 81: movement allowable space, 96: ball (clamping member), D: drive means, E: seating gap, F: locking gap, X: engaging position.

### BEST MODE FOR CARRYING OUT THE PRESENT INVENTION

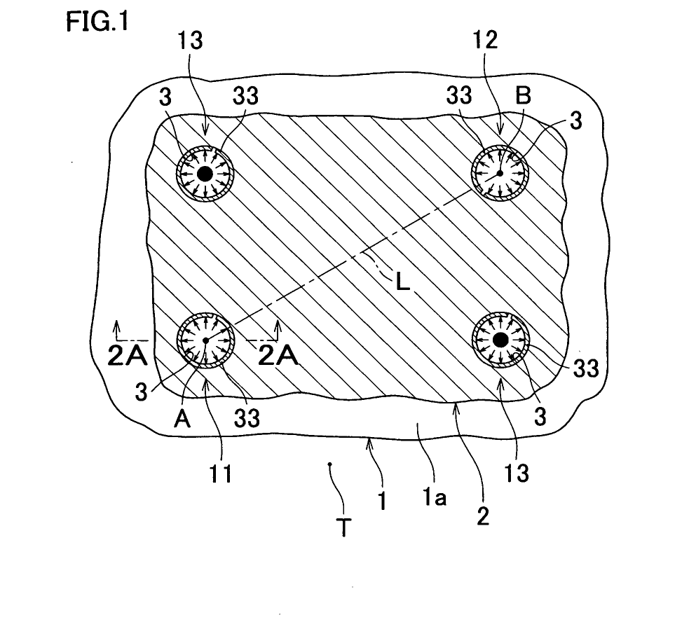

FIG. 1 to FIG. 7B illustrate an embodiment of the present invention, and exemplify that a clamping apparatus of the present invention is applied to a clamping system for a work pallet.

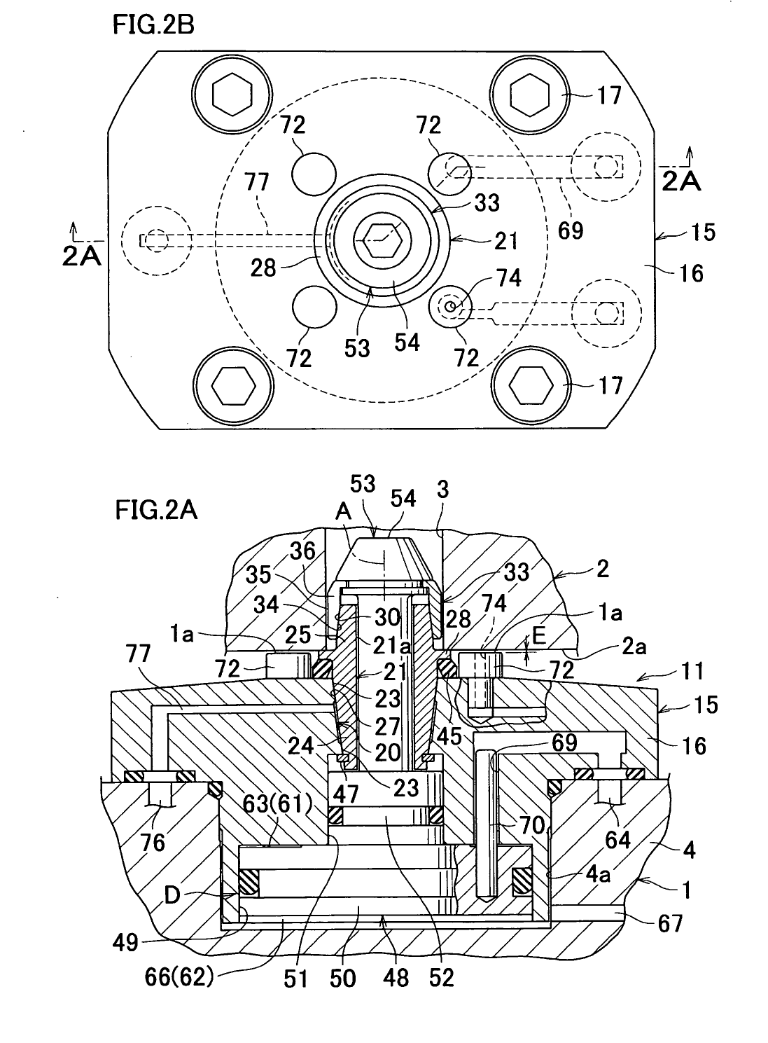

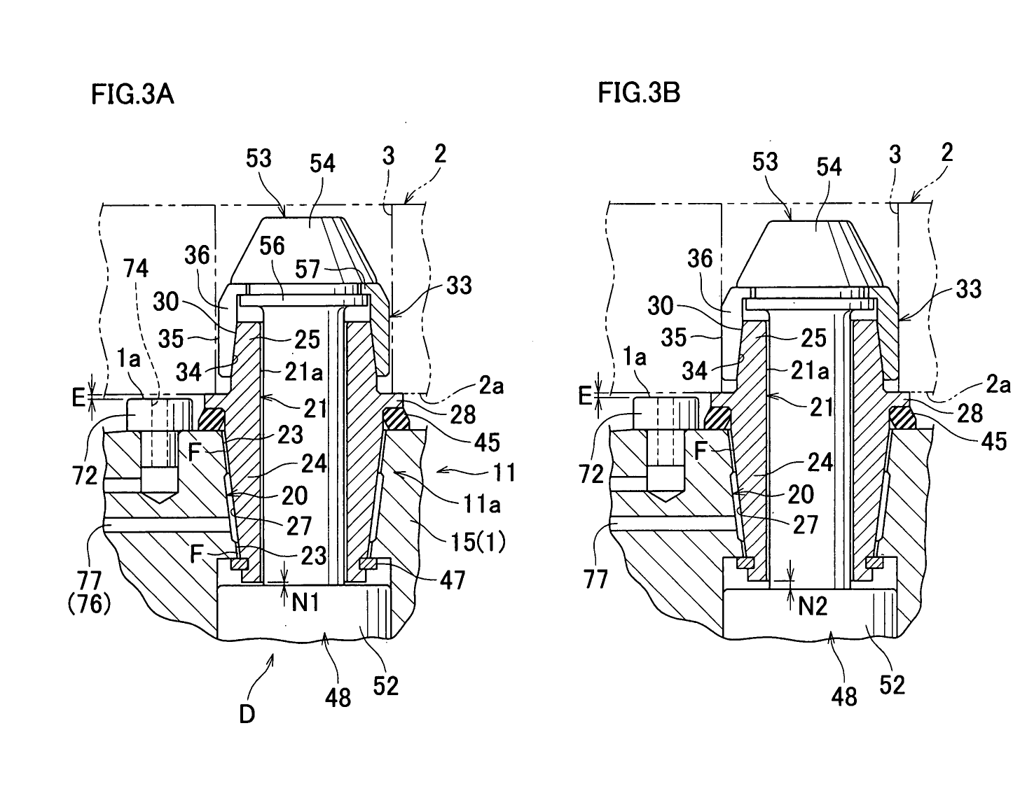

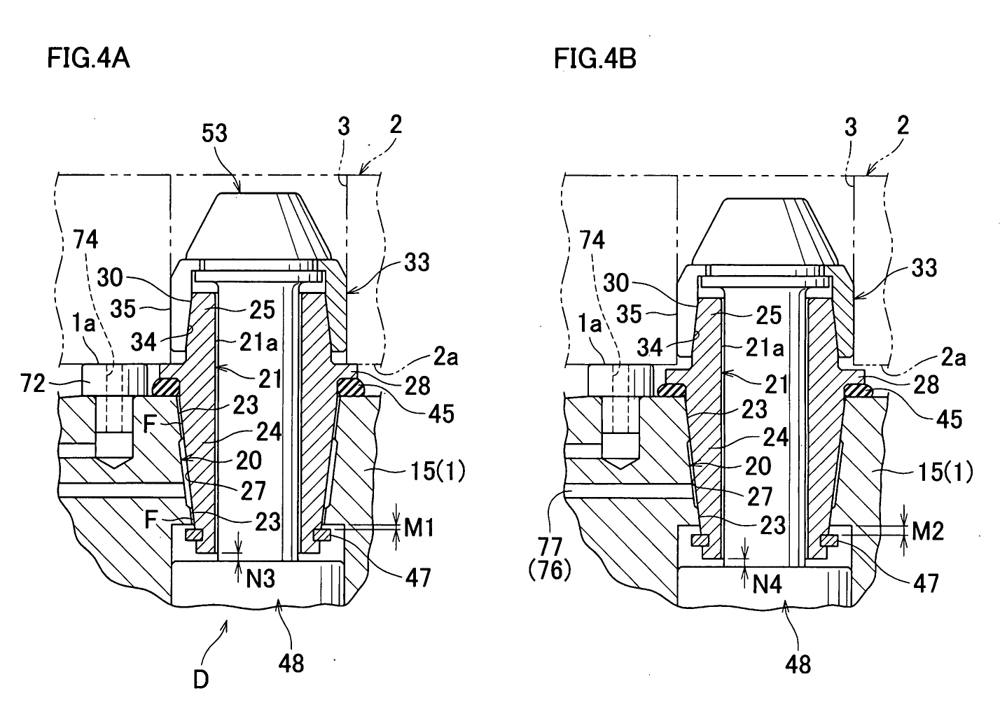

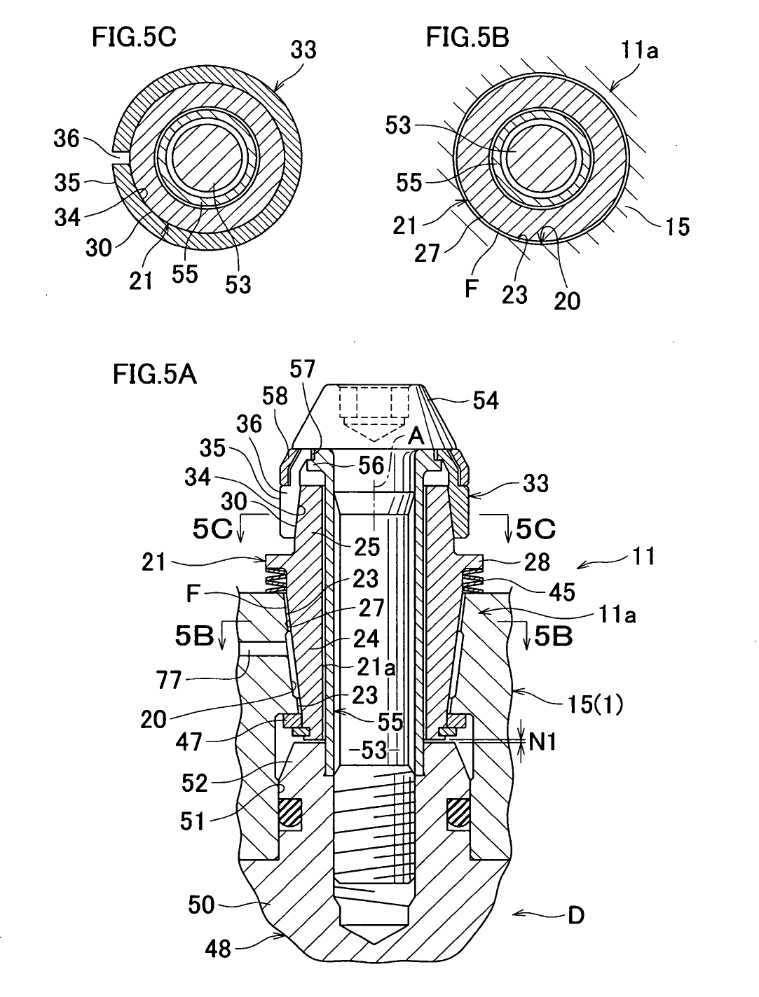

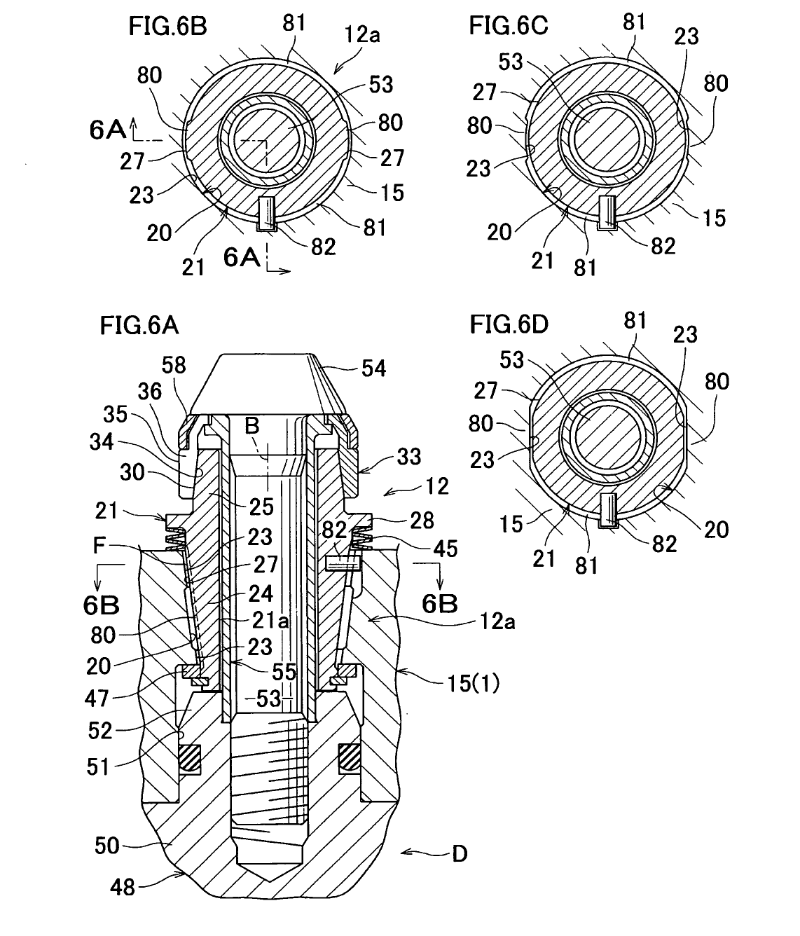

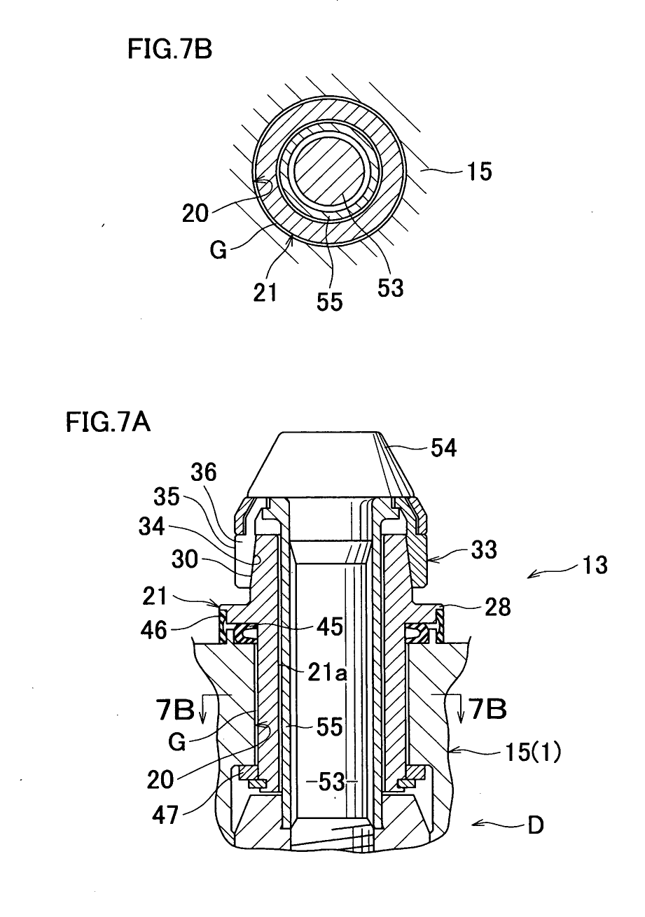

FIG. 1 is a traverse cross-sectional view of the clamping system. FIG. 2A is an elevational view in section of a first clamping apparatus of the clamping system, and a view corresponding to a section taken along the line 2A-2A of FIG. 1 or FIG. 2B. FIG. 2B is a plan view of the clamping apparatus. FIG. 3A to FIG. 4B are operation explanatory diagrams. FIG. 5A to FIG. 5C illustrate an exemplary variation of the first clamping apparatus. FIG. 6A and FIG. 6B illustrate a second clamping apparatus of the clamping system. FIG. 6C and FIG. 6D respectively illustrate an exemplary variation of the second clamping apparatus. FIG. 7A and FIG. 7B illustrate a third clamping apparatus of the clamping system.

In this embodiment, as illustrated in FIG. 1 and FIG. 2A, a reference block 1 is placed on a table T of a machine tool, and a supported surface 2a of a work pallet 2 as a movable block is received on support surfaces 1a of the reference block 1. A plurality of socket holes 3 each composed of a circular straight hole are opened in the supported surface 2a. Here, the four socket holes 3 are illustrated.

The reference block 1 includes a base plate 4 fixed to the table T. To the base plate 4, a first clamping apparatus 11 and a second clamping apparatus 12 with positioning functions and locking functions, and two third clamping apparatuses 13, 13 with only locking functions are provided to correspond to the socket holes 3. The first clamping apparatus 11 and the second clamping apparatus 12 are disposed diagonally, and the two third clamping apparatuses 13, 13 as well are disposed diagonally.

As illustrated in FIG. 1, each of the clamping apparatuses 11, 12, and 13 diametrically expands an annular clamping member 33 described later radially due to wedge action, and drive clamping member 33 downward in a state where substantially the whole circumference of peripheral wall of the annular clamping member 33 are in close contact with the socket holes 3 to fix the work pallet 2 to the reference block 1.

The first clamping apparatus 11 horizontally and vertically positions a rigid sleeve 21 (refer to FIG. 3A), which will be described later, with respect to the reference block 1 at substantially the same time of the close contact of the clamping member 33. Further, the second clamping apparatus 12 positions the rigid sleeve 21 (refer to FIG. 6A) in a horizontal direction substantially perpendicular to a straight line L for connecting a reference axis A and a reference axis B, and vertically positions the rigid sleeve 21, thereby preventing the work pallet 2 from rotating about the axis A. Further, the third clamping apparatus 13 allows the rigid sleeve 21 to move horizontally with respect to the reference block 1 (refer to FIG. 7A and FIG. 7B), and therefore, the third clamping apparatus 13 has only a vertical positioning function, but does not have a horizontal positioning function.

The first clamping apparatus 11 and the second clamping apparatus 12 have the same structure except for differences which will be described later, and basically, the following structure is common thereto.

As illustrated in FIG. 1 to FIG. 2B, a lower portion of a housing 15 is fitted into an installation hole 4a of the base plate 4, and a flange 16 of the housing 15 is fixed to a peripheral wall of the installation hole 4a by four tightening bolts 17.

In an upper half portion of the housing 15, a center hole 20 vertically extending is formed concentrically with the reference axis A (refer to FIG. 1 and FIG. 2A). The center hole 20 is disposed so as to face the socket hole 3. The rigid sleeve 21 is vertically (axially) movably inserted into the center hole 20.

The center hole 20 and the rigid sleeve 21 are constructed as follows as illustrated in an enlarged view of FIG. 3A.

Tapered inner surfaces 23, 23 are respectively formed in an upper portion and a lower portion of an inner periphery of the center hole 20. Each tapered inner surface 23 narrows downward (toward a base end direction).

The rigid sleeve 21 has a base portion 24 inserted into the center hole 20, and a projecting portion 25 capable of being inserted into the socket hole 3. The projecting portion 25 is projected further upward (toward a leading end) than an upper end of the center hole 20.

A tapered outer surface 27 capable of making a tapering engagement with the tapered inner surface 23 is provided on an outer peripheral surface of the base portion 24. It is preferable for tapered angles of the tapered inner surface 23 and the tapered outer surface 27 to be within a range from approximately 5 degrees to approximately 23 degrees, and it is more preferable to be within a range from approximately 10 degrees to approximately 16 degrees.

Further, above the center hole 20, a flange portion 28 is radially-outwardly projected from a lower portion of the projecting portion 25. Moreover, a tapered outer peripheral surface 30 which narrows upward is formed on an upper portion of the projecting portion 25.

A tapered inner peripheral surface 34 of the annular clamping member 33 makes a wedge-engagement with the tapered outer peripheral surface 30 of the rigid sleeve 21 from above. A straight outer peripheral surface 35 of the clamping member 33 is capable of being inserted into the socket hole 3 of the work pallet 2. The clamping member 33 is formed in a collet shape. Specifically, one slit 36 vertically extending is formed in a peripheral wall of the clamping member 33, and thereby, the clamping member 33 is diametrically expandable and diametrically contractible, and diametrically contracts due to its own elastic restoring force.

An elastic member (an advancing means) 45 is disposed between an upper portion of a peripheral wall of the center hole 20 and the flange portion 28. The elastic member 45 is composed of a sealing member such as rubber or synthetic resin, and presses the rigid sleeve 21 upward (toward the leading end). The rigid sleeve 21 is prevented from ascending further than a predetermined quantity by a stopper 47 attached at a lower portion of the rigid sleeve 21.

An output member 48 is inserted into the housing 15 vertically movably. The output member 48 includes a piston 50 hermetically inserted into a cylinder hole 49 in a lower portion of the housing 15, a piston rod 52 which is projected upward from the piston 50 and is hermetically inserted into a rod hole 51, and a connecting rod 53 screwed to the piston rod 52. The connecting rod 53 is inserted into a cylindrical hole 21a of the rigid sleeve 21. An upper flange 57 of the clamping member 33 is fit radially slidably between an upper flange 56 of the connecting rod 53 and a head portion 54 of the connecting rod 53.

As illustrated in FIG. 2A, a lock means 61 and a release means 62 structuring a drive means D are provided in the housing 15. The lock means 61 is composed of the piston 50 and a lock chamber 63 formed above the piston 50. The lock chamber 63 is communicatively connected to a supply and discharge port 64 for pressurized oil for locking. The release means 62 is composed of the piston 50 and a release chamber 66 formed below the piston 50. A supply and discharge port 67 for pressurized oil for releasing is communicatively connected to the release chamber 66.

Further, a throttle pin 70 is fitted into a vertical passage of the supply and discharge passage 69 for locking, and a throttle passage is composed of a fitting gap.

A plurality of bosses 72 are projected upward circumferentially at intervals on an upper surface of the housing 15, and an upper surface of each boss 72 serves as the support surface 1a of the reference block 1.

Further, a seating confirmation means is provided on the first clamping apparatus 11. Specifically, a detection hole 74 is opened in each support surface 1a, and compressed air for detection is supplied to each detection hole 74. Then, when the supported surface 2a of the work pallet 2 is in a contact state with the support surfaces 1a to cause a seating gap E to disappear, pressure in the detection holes 74 is raised. By detecting the rise in pressure by a pressure switch or the like, it is possible to confirm that the work pallet 2 is seated on the housing 15.

Moreover, as illustrated in FIG. 2A and FIG. 3A, a locking confirmation means is provided. Specifically, an air supply port 76 for locking confirmation passes through a lateral passage 77 in the housing 15, a locking gap F between the lower tapered inner surface 23 and the tapered outer surface 27, a communicating groove (not shown) provided in the stopper 47, a gap between the cylindrical hole 21a of the rigid sleeve 21 and an outer peripheral surface of the connecting rod 53, and the slit 36 of the clamping member 33 in the recited order, to be communicatively connected to an exterior space. Then, when the tapered outer surface 27 comes into contact with the tapered inner surface 23 to shut off the communicative connection, pressure in the air supply port 76 is raised. By detecting the rise in pressure by a pressure switch or the like, it is confirmed that the clamping member 33 and the rigid sleeve 21 descend to be in a lock state.

Further, although it has been described that the communicating groove (not shown) is provided in the stopper 47, instead thereof, the locking gap F between the upper tapered inner surface 23 and the tapered outer surface 27 may be communicatively connected to the cylindrical hole 21a of the rigid sleeve 21 via a communicating passage (not shown).

Substantially the whole circumference of each of the peripheral walls of the annular clamping members 33 of the respective clamping apparatuses 11, 12, and 13 is made to diametrically expand radially-outwardly by the tapered outer peripheral surface 30 of the rigid sleeve 21.

Further, as illustrated in FIG. 2A and FIG. 3A (and refer to FIG. 5B which will be described later), a positioning mechanism 11a of the first clamping apparatus 11 is constructed such that the tapered outer surface 27 of the rigid sleeve 21 is capable of making a tapering engagement with substantially the whole circumference of the tapered inner surface 23 of the center hole 20.

FIG. 5A to FIG. 5C illustrate an exemplary variation of the first clamping apparatus 11. FIG. 5A is a view similar to FIG. 3A. FIG. 5B is a section taken along the line 5B-5B of FIG. 5A. FIG. 5C is a section taken along the line 5C-5C of FIG. 5A.

In this case, a pipe 55 is arranged between the head portion 54 of the connecting rod 53 and the piston rod 52, and the connecting rod 53 is inserted into the pipe 55. Further, the advancing means 45 is composed of a plurality of coned disc springs vertically laminated. Moreover, an outer periphery of an upper half portion of the collet type clamp 33 is covered with a cover tube 58. The cover tube 58 prevents foreign matter such as swarf from intruding into the rigid sleeve 21 through the slit 36.

As illustrated in FIG. 6A and FIG. 6B, a positioning mechanism 12a of the second clamping apparatus 12 is different in the following structure from the positioning mechanism 11a of the first clamping apparatus 11. FIG. 6A is a view similar to FIG. 5A, illustrating a section taken along the line 6A-6A of FIG. 6B. FIG. 6B is a section taken along the line 6B-6B of FIG. 6A.

A pair of protruding portions 80, 80 radially facing each other is provided on the outer periphery of the rigid sleeve 21, and the tapered outer surface 27 is formed on each protruding portion 80. Then, movement allowable spaces 81, 81 partitioned by the protruding portions 80, 80 are formed to radially face each other between the inner periphery of the center hole 20 and the outer periphery of the rigid sleeve 21. Thereby, the rigid sleeve 21 functions so as to eliminate a fitting gap in the facing direction of the protruding portions 80, 80, and on the other hand, the rigid sleeve 21 is allowed to move in a radial direction perpendicular to the facing direction. Further, reference number 82 in FIG. 6A and FIG. 6B denotes a rotation stopper pin.

FIG. 6C illustrates a first exemplary variation of the positioning mechanism 12a. In this case, a pair of the protruding portions 80, 80 radially facing each other is provided on the inner periphery of the center hole 20, and the tapered inner surface 23 is formed to each protruding portion 80. A pair of the movement allowable spaces 81, 81 as well are formed in the same way as in FIG. 6B.

A second exemplary variation of FIG. 6D is that the first exemplary variation of FIG. 6C is modified as follows. Specifically, each of the tapered inner surface 23 and the tapered outer surface 27 is composed of a flat surface instead of a circular surface.

The third clamping apparatus 13 is different in the following structure from the first clamping apparatus 11 as illustrated in FIG. 7A and FIG. 7B.

The both peripheral surfaces of the inner peripheral surface of the center hole 20 and the outer peripheral surface of the rigid sleeve 21 are formed in a vertically straight manner, and an annular gap G for allowing the rigid sleeve 21 to radially move is provided between the both peripheral surfaces. Thereby, it is possible to absorb a misalignment between an axis of the socket hole 3 and an axis of the center hole 20.

Further, a dust seal 46 is installed on an outer periphery of the annular rubber advancing means 45.

The respective clamping apparatuses 11, 12, and 13 operate as follows substantially in the same way.

In a release state of FIG. 2A and FIG. 3A, pressurized oil in the lock chamber 63 is discharged and pressurized oil is supplied to the release chamber 66. Thereby, the piston 50 raises the annular clamping member 33 via the connecting rod 53, and the clamping member 33 is changed to be in a diametrically contracted state. The rigid sleeve 21 ascends by an advancing stroke by the elastic member 45 as an advancing means, and lightly makes a tapering engagement with the clamping member 33 or faces the clamping member 33 with a slight gap.

When the work pallet 2 is positioned with respect to the reference block 1, first, as illustrated in FIG. 1 and FIG. 2A (and FIG. 3A), the work pallet 2 is lowered in the release state mentioned above, and the socket hole 3 is fitted at the outside of the clamping member 33, and the work pallet 2 is received by the flange portion 28 of the rigid sleeve 21. In this state, the seating gap E is formed between the support surfaces 1a and the supported surface 2a. Further, as illustrated in FIG. 3A, the locking gap F is formed between the tapered inner surface 23 and the tapered outer surface 27, and a minute contact gap N1 is formed between an upper end surface of the piston rod 52 and a lower end surface of the rigid sleeve 21.

Further, since the locking gap F is provided as described above, when the socket hole 3 of the work pallet 2 is fitted at the outside of the clamping member 33, it is possible to allow a misalignment between an axis of the socket hole 3 and an axis of the rigid sleeve 21.

Next, the pressurized oil in the release chamber 66 is discharged and pressurized oil is supplied to the lock chamber 63. Then, the piston 50 lowers the clamping member 33 via the connecting rod 53, and the tapered inner peripheral surface 34 of the clamping member 33 makes a wedge-engagement with the tapered outer peripheral surface 30 of the rigid sleeve 21.

Thereby, as illustrated in FIG. 3B, the clamping member 33 diametrically expands with respect to the rigid sleeve 21 held substantially at a raised position by urging force of the elastic member 45 to come into contact with the socket hole 3. In a locking start state of FIG. 3B, a contact gap N2 greater than the contact gap N1 of FIG. 3A is formed between the upper end surface of the piston rod 52 and the lower end surface of the rigid sleeve 21.

Next, as illustrated in FIG. 4A, the clamping member 33 diametrically expands while compressing the elastic member 45 downward via the rigid sleeve 21 to come into close contact with the socket hole 3. Substantially at the same time, the supported surface 2a of the work pallet 2 comes into contact with the support surfaces 1a of the reference block 1. Then, in a half-locked state of FIG. 4A, a descending stroke M1 corresponding to the seating gap E of FIG. 3B is formed above the stopper 47, and a contact gap N3 slightly greater than the contact gap N2 of FIG. 3B is formed between the upper end surface of the piston rod 52 and the lower end surface of the rigid sleeve 21.

Then, as illustrated in FIG. 4B, the clamping member 33 moves while sliding downward along the inner peripheral surface of the socket hole 3, and the clamping member 33 further lowers the rigid sleeve 21 while compressing the elastic member 45. And, when the rigid sleeve 21 descends by a descending stroke M2 corresponding to the advancing stroke, the tapered surface 27 of the rigid sleeve 21 makes a tapering engagement with the tapered inner surface 23 of the center hole 20.

Thereby, the rigid sleeve 21 is radially (horizontally) and axially (vertically) constrained by the reference block 1 via the tapering engagement. Then, the work pallet 2 is horizontally positioned with respect to the housing 15 via the rigid sleeve 21 in the constrained state and the clamping member 33 in close contact with the socket hole 3.

Substantially at the same time, by driving the output member 48 to further descend with respect to the rigid sleeve 21, the tapered inner peripheral surface 34 of the clamping member 33 makes a strong wedge-engagement with the tapered outer peripheral surface 30 of the rigid sleeve 21 received by the housing 15 to diametrically expand, and the straight outer peripheral surface 35 of the clamping member 33 comes into strong and close contact with the socket hole 3. Then, the connecting rod 53 strongly presses the supported surface 2a of the work pallet 2 onto the support surfaces 1a of the reference block 1 via the clamping member 33 in a strong and close contact state.

In a locking completed state of FIG. 4B, due to the tapered outer surface 27 of the rigid sleeve 21 making a tapering engagement with the tapered inner surface 23 of the center hole 20, the pressure in the air supply port 76 for locking confirmation is raised, and by detecting the rise in pressure, it is possible to confirm the lock state. Further, due to the supported surface 2a coming into contact with the support surfaces 1a, the pressure in the detection holes 74 is raised, and by detecting the rise in pressure, it is possible to confirm that the work pallet 2 is seated.

Further, in the release state of FIG. 3A and at the time of locking start of FIG. 3B, the support surfaces 1a and the supported surface 2a may be substantially completely in a contact state with each other. In this case, during the locking movement, the clamping member 33 operates as follows.

After the clamping member 33 comes into close contact with the socket hole 3, the clamping member 33 descends while sliding along the socket 3. Then, as described above, when the tapered outer surface 27 of the rigid sleeve 21 makes a tapering engagement with the tapered inner surface 23, the clamping member 33 comes into strong and close contact with the socket hole 3, and the clamping member 33 presses the work pallet 2 onto the reference block 1.

In parallel with the operations of the first clamping apparatus 11 and the second clamping apparatus 12, the two third clamping apparatuses 13, 13 with only locking functions firmly fix the work pallet 2 to the reference block 1 via the clamping member 33.

To change from the lock state to the release state, as described above, it is only required that the pressurized oil in the lock chamber 63 be discharged and pressurized oil be supplied to the release chamber 66. Thereby, since the piston 50 raises the clamping member 33 via the connecting rod 53, and the clamping member 33 diametrically contracts due to its own elastic restoring force, the lock state is released.

Further, during the releasing drive, it is also conceived that the contact gap N1 illustrated in FIG. 3A is eliminated, and the piston rod 52 forcibly presses up the rigid sleeve 21.

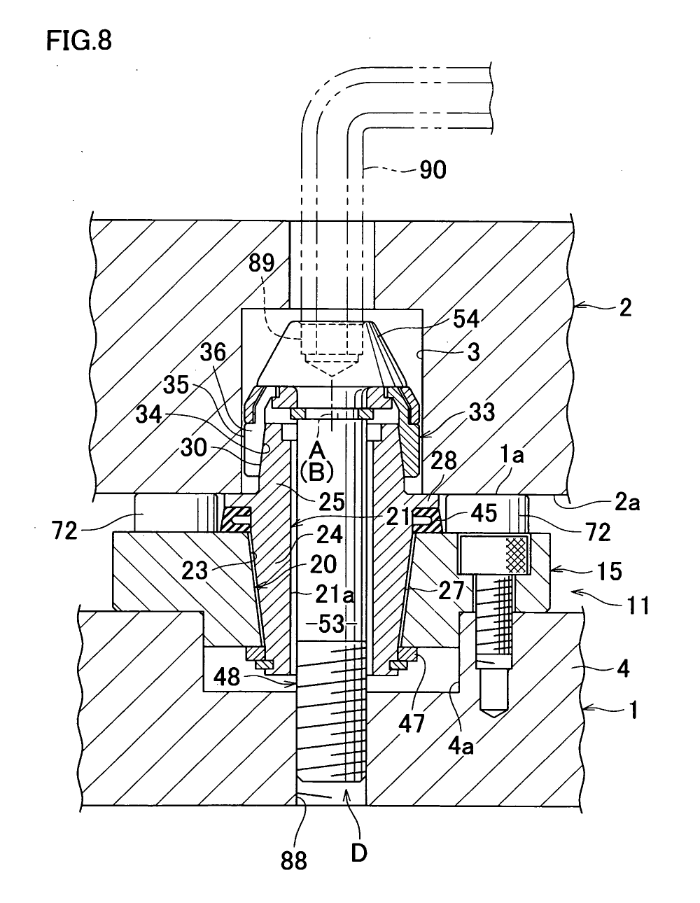

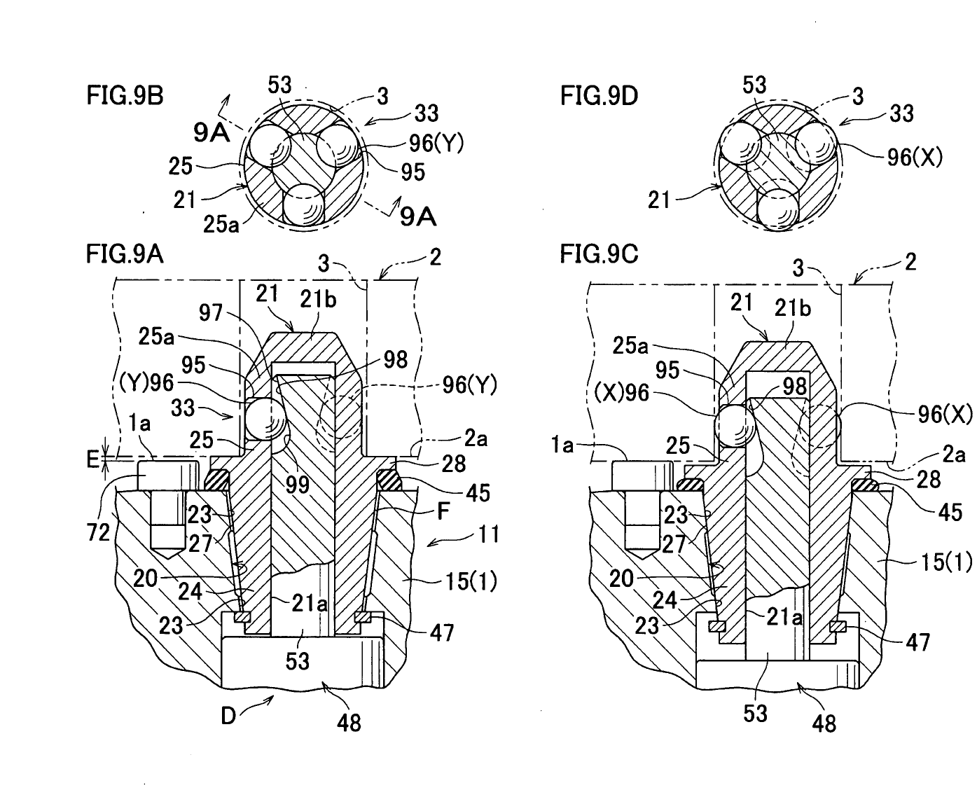

FIG. 8 and FIG. 9A to FIG. 9D respectively illustrate a second embodiment and a third embodiment of the first clamping apparatus 11 according to the present invention. In these embodiments, components similar to those of the first embodiment will be designated and described by the same numerals as a general rule, and structures different from those of the first embodiment will be described.

FIG. 8 illustrating the second embodiment is a view similar to FIG. 2A. In this case, the drive means D is constructed to be a human-powered type.

To describe in greater detail, the lower portion of the connecting rod 53 is threaded into a screw hole 88 of the base plate 4. And, during a locking drive, a hexagonal wrench 90 is inserted into an input hole 89 of the head portion 54 of the connecting rod 53, and the connecting rod 53 is rotated in a clockwise direction in plan view. Then, the head portion 54 lowers the clamping member 33 while diametrically expanding the clamping member 33.

Moreover, the elastic member (the advancing means) 45 is formed into a lateral U-shape in section.

Further, the base plate 4 and the housing 15 may be integrally formed, instead of being separately constructed as exemplified.

The clamping member 33 of the respective embodiments may be a clamping member in which a plurality of through grooves alternately opened in an upper surface and a lower surface of its peripheral wall are circumferentially provided, instead of a clamping member in which one slit 36 is provided to the peripheral wall. Moreover, the clamping member 33 may be composed of a plurality of divided bodies arranged circumferentially.

Further, the outer surface of the clamping member 33 may be formed into a serrated manner or into an uneven manner, instead of being formed vertically straight. Further, it is a matter of course that the clamping member 33 is not limited to the above-described structures, but well-known various structures may be employed.

FIG. 9A to FIG. 9D illustrate a third embodiment of the first clamping apparatus 11. FIG. 9A is a cross section corresponding to a section taken along the line 9A-9A of FIG. 9B, illustrating a release state of the clamping apparatus 11. FIG. 9B is a section in plan view of FIG. 9A. FIG. 9C is a view similar to FIG. 9A, illustrating a lock state of the clamping apparatus. FIG. 9D is a section in plan view of FIG. 9C.

The rigid sleeve 21 includes a top wall 21b. Further, three through holes 95 radially extending are formed circumferentially at intervals in a peripheral wall 25a of the projecting portion 25 of the rigid sleeve 21. Balls 96 are inserted radially movably into the respective through holes 95. By narrowing outer end portions of the through holes 95, the balls 96 are prevented from getting out to the outside. The plurality of balls 96 serve as the clamping member 33.

A groove 97 vertically extending is formed to correspond to the respective balls 96 in the upper portion (leading end portion) of the connecting rod 53 of the output member 48. The groove 97 has an output surface 98 and a retreating surface 99.

In a release state of FIG. 9A and FIG. 9B, the rigid sleeve 21 is held at a raised position by urging force of the elastic member 45. Further, the output member 48 ascends with respect to the rigid sleeve 21, and the retreating surface 99 faces the balls 96. Therefore, the respective balls 96 are allowed to change to a radially-inward engagement cancellation position Y (here, a state in which the balls 96 have already been changed to the engagement cancellation position Y is illustrated).

When the work pallet 2 is positioned with respect to the reference block 1, first, as illustrated in FIG. 9A, the work pallet 2 is lowered in the release state to make the socket holes 3 be fitted at the outside of the plurality of balls 96, and the work pallet 2 is received by the flange portion 28 of the rigid sleeve 21.

In this state, the seating gap E is formed between the support surfaces 1a and the supported surface 2a, and the locking gap F is formed between the tapered inner surface 23 and the tapered outer surface 27.

During a locking drive, the output member 48 is lowered. Then, the output surface 98 of the connecting rod 53 pushes out the balls 96 toward the outside. Thereby, the balls 96 radially-outwardly move in the through holes 95 of the rigid sleeve 21, and the respective balls 96 come into contact with the socket hole 3.

Next, as illustrated in FIG. 9C and FIG. 9D, the balls 96 changed to radially-outward engaging positions X come into close contact with the socket holes 3 while compressing the elastic member 45 downward via the rigid sleeve 21, and substantially at the same time, the supported surface 2a of the work pallet 2 comes into contact with the support surfaces 1a of the reference block 1.

Then, the plurality of balls 96 move while sliding downward along the inner peripheral surface of the socket hole 3 (or, while the balls 96 elastically deform or plastically deform the inner peripheral surface of the socket hole 3), and the plurality of balls 96 further lower the rigid sleeve 21 against the elastic member 45, and the tapered outer surface 27 of the rigid sleeve 21 makes a tapering engagement with the tapered inner surface 23 of the center hole 20.

Thereby, the rigid sleeve 21 is radially (horizontally) and axially (vertically) constrained by the reference block 1 via the tapering engagement. And, the work pallet 2 is horizontally positioned with respect to the housing 15 via the rigid sleeve 21 in the constrained state and the plurality of balls 96 in a close contact state with the socket hole 3.

Substantially at the same time, by driving the output member 48 to further descend with respect to the rigid sleeve 21, the plurality of balls 96 come into strong and close contact with the socket hole 3. Then, the connecting rod 53 strongly presses the supported surface 2a of the work pallet 2 onto the support surfaces 1a of the reference block 1 via the plurality of balls 96 in a strong and close contact state therewith.

Further, the numbers of the through holes 95 and the balls 96 to be installed may be respectively two, or four or more, instead of three.

The respective embodiments and exemplary variations may be modified as follows.

Three or more tapered inner surfaces 23 of the center hole 20 may be provided, instead of providing vertically two or one thereof.

The tapered inner surface 23 of the center hole 20 and the tapered outer surface 27 of the rigid sleeve 21 are preferably circular tapered surfaces in section. However, instead thereof, those may be elliptical tapered surfaces, or may be a plurality of sloping wedge surfaces arranged circumferentially at predetermined intervals. In this case, a plurality of inclined grooves may be arranged circumferentially at predetermined intervals in the tapered inner surface 23 and the tapered outer surface 27, and each wedge surface may be composed of bottom wall of each inclined groove.

The advancing means 45 may be any means to press the rigid sleeve 21 upward (toward the leading end). Accordingly, the advancing means 45 may be attached between a lower portion of the rigid sleeve 21 and the housing 15, instead of being attached between the flange portion 28 of the rigid sleeve 21 and the housing 15. Further, the advancing means 45 may utilize a combination of pressurized fluid such as compressed air or pressurized oil and a piston, instead of or in addition to the exemplified elastic member such as rubber and a spring such as a coned disc spring.

It is preferable that cleaning means are provided to the respective clamping apparatuses 11, 12, and 13, and contact portions between the support surfaces 1a and the supported surface 2a, a fitting portion between the socket hole 3 and the clamping member 33, fitting portions between the balls 96 and the through holes 95, and respective fitting surfaces between the tapered inner surfaces 23 and the tapered outer surface 27 are cleaned by pressurized fluid such as compressed air.

In the clamping system, only one, or three or more third clamping apparatuses 13 with only locking functions may be installed, instead of the exemplified two. The third clamping apparatus 13 is not limited to the exemplified structure, and may be another type of clamp.

The driving type of each of the clamping apparatuses 11, 12, and 13 may be a spring locking and hydraulic releasing type or a hydraulic locking and spring releasing type, instead of the exemplified hydraulic double-acting type.

Pressurized fluid used for locking or releasing may be gas such as compressed air, instead of the exemplified pressurized oil. Further, pressurized fluid for cleaning may be gas such as nitrogen or liquid, instead of the exemplified compressed air.

Provided that lowering force of clamping during the locking drive is set to a sufficiently great value, it is possible to omit the third clamping apparatus 13.

Further, in the clamping system, the first clamping apparatus 11 may be installed in plural numbers, and the second clamping apparatus 12 may be installed in plural numbers. Moreover, any one of both of the first clamping apparatus 11 and the second clamping apparatus 12 may be installed in plural numbers.

As a direction in which a plurality of the clamping apparatuses are arranged, a circular direction or a straight direction may be conceived.

The support surface 1a may be provided on the base plate 4, instead of being provided on the upper surface of each boss 72 of the housing 15.

Further, the housing 15 and the base plate 4 may be integrally formed, instead of being separately formed.

The combination of the reference block and the movable block may be a combination of a table of a machine tool and a work pallet, a combination of a work pallet and a jig base, a combination of a jig base and a work piece, or a combination of a working jig such as a welding jig and a working article such as a work piece, instead of the exemplified combination of the base plate 4 and the work pallet 2. Further, the present invention is applicable to positioning of a work piece, a tool and the like used in various processing machines such as a laser processing machine and an electric discharge processing machine.

Further, it is a matter of course that the clamping apparatuses of the present invention can be used only as one set, instead of being used as plural sets.

1. A clamping apparatus which clamps a movable block (2) having a socket hole (3) to a reference block (1), comprising:
a center hole (20) provided in the reference block (1) so as to face the socket hole (3), the center hole (20) having a tapered inner surface (23) narrowing toward a base end;
a rigid sleeve (21) supported by the reference block (1) axially movably within a predetermined range, the rigid sleeve (21) including a tapered outer surface (27) making a tapering engagement with the tapered inner surface (23) of the center hole (20), a projecting portion (25) projected further toward a leading end than the center hole (20) and inserted into the socket hole (3), and a cylindrical hole (21a) axially extending;
an advancing means (45) for pressing the rigid sleeve (21) toward the leading end;
an output member (48) inserted into the cylindrical hole (21a) of the rigid sleeve (21), the output member (48) being connected to a clamping member (33) provided on the projecting portion (25) so as to be inserted into the socket hole (3); and
a driving means (D) for moving the output member (48) toward the base end, wherein the output member (48) moves the clamping member (33) toward the base end against the advancing means (45) and radially-outwardly for locking, and makes the tapered outer surface (27) of the rigid sleeve (21) form a tapering engagement with the tapered inner surface (23) of the center hole (20).

2. The clamping apparatus according to claim 1, wherein
a flange portion (28) is radially-outwardly projected from the rigid sleeve (21) outside the center hole (20), and the advancing means (45) is disposed in an annular manner between the flange portion (28) and the reference block (1).

3. The clamping apparatus according to claim 2, wherein
the annular advancing means (45) is composed of an elastic member for sealing such as rubber or synthetic resin.

4. The clamping apparatus according to claim 1, wherein
a flange portion (28) is radially-outwardly projected from the rigid sleeve (21) outside the center hole (20), and in a state where the movable block (2) is placed on the flange portion (28), the advancing means (45) presses the movable block (2) to form a seating gap (E) between a supported surface (2a) of the movable block (2) and a support surface (1a) of the reference block (1), and
a detection hole (74) for pressurized fluid for seating confirmation is opened in the support surface (1a).

5. The clamping apparatus according to claim 1, wherein
a supply port (76) for pressurized fluid for locking confirmation is provided in the reference block (1), the supply port (76) is communicatively connected to an exterior space via a locking gap (F) between the tapered inner surface (23) and the tapered outer surface (27), and the communicative connection between the supply port (76) and the exterior space is shut off when the tapered outer surface (27) makes a tapering engagement with the tapered inner surface (23).

6. The clamping apparatus according to any one of claims 1 to 5, wherein
the tapered outer surface (27) of the rigid sleeve (21) makes a tapering engagement with substantially the whole circumference of the tapered inner surface (23) of the center hole (20) provided in the reference block (1).

7. The clamping apparatus according to claim 1, wherein
a pair of protruding portions (80, 80) radially facing each other is provided on at least one of an inner periphery of the center hole (20) provided in the reference block (1) and an outer periphery of the rigid sleeve (21), and the tapered inner surface (23) or the tapered outer surface (27) is formed to the respective protruding portions (80), and
movement allowable spaces (81, 81) partitioned by the protruding portions (80, 80) are formed to radially face each other between the inner periphery of the center hole (20) and the outer periphery of the rigid sleeve (21).

8. The clamping apparatus according to claim 1, wherein
the clamping member (33) is composed of a collet diametrically expandable and diametrically contractible, and the collet type clamping member (33) makes a wedge-engagement with the projecting portion (25) of the rigid sleeve (21) from the leading end side.

9. The clamping apparatus according to claim 1, wherein
the clamping member (33) is composed of a plurality of balls (96) arranged circumferentially at intervals on a peripheral wall of the projecting portion (25) of the rigid sleeve (21), and the output member (48) changes the respective balls (96) to radially-outward engaging positions (X).

10. The clamping apparatus according to claim 9, wherein
at least three of the balls (96) are provided.

11. A clamping system comprising at least one of the clamping apparatuses according to claim 1.

12. A clamping system comprising the clamping apparatus according to claim 6, and the clamping apparatus according to claim 7.

13. A clamping system comprising at least two of the clamping apparatuses according to claim 7.
